(19) United States
(12) Patent Application Publication
(10) Pub. No.: US 2022/0372250 A1
(43) Pub. Date: Nov. 24, 2022

(54) A SURFACE COATED CELLULOSIC FILM

(71) Applicant: Stora Enso OYJ, Helsinki (FI)

(72) Inventors: Kaj Backfolk, Lappeenranta (FI); Katja Lyytikäinen, Imatra (FI); Isto Heiskanen, Imatra (FI); Otto Nylén, Helsinki (FI)

(73) Assignee: Stora Enso OYJ, Helsinki (FI)

(21) Appl. No.: 17/755,340

(22) PCT Filed: Nov. 4, 2020
(86) PCT No.: PCT/IB2020/060347

§ 371 Date: Apr. 27, 2022

(30) Foreign Application Priority Data
Nov. 4, 2019 (SE) 1951261-5

(51) Int. Cl. C08L 1/02; C08B 15/00; C08J 5/18; C08J 7/04; C09D 101/28; D21H 11/18; D21H 19/34; B82Y 30/00

(52) U.S. Cl. CPC C08L 1/02; C08B 15/005; C08J 5/18; C08J 7/0427; C09D 101/286; D21H 11/18; D21H 19/34; B82Y 30/00; C08J 2301/02; C08L 2203/16; C08L 2312/00

(57) ABSTRACT

A cellulosic film comprising MFC is provided, which is coated on at least one surface thereof with at least one cured barrier layer. The cured barrier layer comprises CMC which has been crosslinked with a crosslinking agent. A method for improving the barrier properties of a cellulosic film is also provided.

### TECHNICAL FIELD

A coated cellulosic film comprising MFC is provided, which is coated on at least one surface thereof with at least one cured barrier layer. The cured barrier layer comprises CMC which has been crosslinked with a crosslinking agent. The MFC film has improved barrier properties, in particular an improved barrier to grease. A method for improving the barrier properties of a cellulosic film is also provided.

### BACKGROUND

One problem with microfibrillated cellulose (MFC) film manufacturing is that film quality is determined almost exclusively by the dewatering and drying steps. At higher manufacturing speeds, the film forming is affected negatively and this leads to reduced barrier properties.

Different solutions are not always technically available, but might include e.g. extended press dewatering, slower manufacturing speeds, the use of multilayers etc.

Surface coating (sizing) with chemicals is also one possible solution. Various polymers are used in the coating composition, but this typically provides limited storage stability due to retrogradation and uncontrolled cross-linking behaviour.

Thus, there is a need to find coating compositions that addresses the problems of, inter alia:
storage stability
low viscosity and high consistency
enhanced water vapour transfer rate (WVTR) and oxygen transfer rate (OTR)

for a cellulose (MFC) film.

Preferably, the coating composition improves at least two barrier properties simultaneously, e.g. improved grease barrier, and improved OTR and/or WVTR. The solution has also enhanced barrier properties determined at tropical conditions (38° C./85% RH). Hydrophilic papers and coatings usually provide good gas and aroma barrier when measured at low relative humidity. The problem is their moisture sensitivity, which leads to swelling and defects in barrier layers.

### SUMMARY

It has been found by the present inventor(s) that, when a low viscosity CMC is dispersed in a crosslinker such as citric acid, a coating composition can be prepared at high consistency while maintaining low or moderate viscosity. The composition is further storage and temperature stable and provides less waste.

So, in a first aspect a method for improving the barrier properties of a cellulosic film comprising microfibrillated cellulose (MFC) is provided. The method comprises the steps of:
a. providing a cellulosic film comprising MFC;
b. applying a barrier coating composition to at least one surface of said cellulosic film; said barrier coating composition comprising a crosslinking agent and carboxymethyl cellulose (CMC),
   or
   applying an aqueous solution comprising a crosslinking agent and an aqueous solution and/or suspension comprising carboxymethyl cellulose (CMC) to the same surface of said cellulosic film; thereby forming a barrier coating composition on said surface of the cellulosic film; and
c. curing said barrier coating composition so as to form a barrier layer coated on said cellulosic film.

In a second aspect, a coated cellulosic film comprising MFC is provided, said cellulosic film being coated on at least one surface thereof with at least one cured barrier layer, wherein said cured barrier layer comprises CMC which has been crosslinked with a crosslinking agent.

In a further aspect, a barrier coating composition is provided, said barrier coating composition comprising a crosslinking agent and carboxymethyl cellulose (CMC).

Further details of the invention are apparent from the following description text, the examples and the claims.

### DETAILED DISCLOSURE

The present invention provides a method for improving the barrier properties of a cellulosic film comprising microfibrillated cellulose (MFC), as well as a coated cellulosic film comprising MFC. The cellulosic film used in the present technology suitably has a weight of 10-70 gsm, preferably 15-60 gsm and more preferably 20-50 gsm, even more preferably 20-35 gsm, before coating. The term “cellulosic film” includes thin paper barriers, such as various wrapping or packaging papers. The coated cellulosic film can, in addition to industrial packaging, be used in food packaging, cosmetic and personal care, electronics, etc, where a barrier to grease/oil is desired. The coated film is particularly of interest for use in various laminates.

In a first step of the method, a cellulosic film comprising MFC is provided. There are different synonyms for MFC such as cellulose microfibrils, fibrillated cellulose, nanocellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. The cellulose fiber is preferably fibrillated to such an extent that the final specific surface area of the formed microfibrillated cellulose is from about 1 to about 400 m²/g, such as from 10 to 300 m²/g or more preferably 50-200 m²/g when determined for a solvent exchanged and freeze-dried material with the BET method. The mean average fibril diameter of the MFC is 1-1000 nm, preferably 10-1000 nm. In an embodiment, the MFC comprises at least 50 wt %, such as at least 60 wt %, suitably at least 70 wt % of fibrils having a mean average fibril diameter less than 100 nm. The MFC may be characterised by analysing high resolution SEM or ESEM images.

Various methods exist to make microfibrillated cellulose, such as single or multiple pass refining, pre-hydrolysis followed by refining or high shear disintegration or liberation of fibrils. One or several pre-treatment steps are usually required in order to make microfibrillated cellulose manufacturing both energy-efficient and sustainable. The cellulose fibers of the pulp to be supplied may thus be pre-treated enzymatically or chemically, for example to reduce the quantity of hem icellulose or lignin. The cellulose fibers may be chemically modified before fibrillation, wherein the cellulose molecules contain functional groups other (or more) than found in the original cellulose. Such groups include, among others, carboxymethyl, aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into microfibrillated cellulose.

The microfibrillated cellulose may contain some hemicelluloses; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, single- or twin-screw extruder, fluidizer such as microfluidizer, macrofluidizer or other fluidizer-type homogenizer. Depending on the MFC manufacturing method, the product might also contain fines, or nanocrystalline cellulose or e.g. other chemicals present in wood fibers or in papermaking process. The product might also contain various amounts of micron-sized fiber particles that have not been efficiently fibrillated.

Microfibrillated cellulose can be produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper, i.e. pre and post-consumer waste.

The microfibrillated cellulose can be native (i.e. chemically unmodified), or it can be chemically modified. Phosphorylated microfibrillated cellulose (P-MFC) is typically obtained by reacting cellulose fibers soaked in a solution of NH₄H₂PO₄, water and urea and subsequently fibrillating the fibers to P-MFC. One particular method involves providing a suspension of cellulose pulp fibers in water, and phosphorylating the cellulose pulp fibers in said water suspension with a phosphorylating agent, followed by fibrillation with methods common in the art. Suitable phosphorylating agents include phosphoric acid, phosphorus pentaoxide, phosphorus oxychloride, diammonium hydrogen phosphate and sodium dihydrogen phosphate.

A suspension of microfibrillated cellulose is used to form the cellulosic film. Typically, the cellulosic film comprises microfibrillated cellulose in an amount of between 0.01-100 wt % based on total solid content, such as between 30 and 100 wt %, suitably between 40 and 100 wt %, such as between 50 and 100 wt %, or between 70 and 100 wt %.

The suspension used to form the cellulosic film is typically an aqueous suspension. The suspension may comprise additional chemical components known from papermaking processes. Examples of these may be nanofillers or fillers such as nanoclays, bentonite, talc, calcium carbonate, kaolin, SiO₂, Al₂O₃, TiO₂, gypsum, etc. The fibrous substrate may also contain strengthening agents such as cellulose derivatives or native starch or modified starch such as, for example, cationic starch, nonionic starch, anionic starch or amphoteric starch. The strengthening agent can also be synthetic polymers. In a further embodiment, the fibrous substrate may also contain retention and drainage chemicals such as cationic polyacrylamide, anionic polyacrylamide, silica, nanoclays, alum, PDADMAC, PEI, PVAm, etc. In yet a further embodiment, the cellulosic film may also contain other typical process or performance chemicals such as dyes or fluorescent whitening agents, defoamers, wet strength resins, biocides, hydrophobic agents, barrier chemicals etc.

The microfibrillated cellulose suspension may additionally comprise cationic or anionic microfibrillated cellulose; such as carboxymethylated microfibrillated cellulose. In an embodiment, the cationic or anionic microfibrillated cellulose is present in an amount of less than 50 wt % of the total amount of microfibrillated cellulose, preferably in an amount of less than 40 wt %, or more preferably in an amount of less than 30 wt %.

The forming process of the cellulosic film from the suspension may be casting or wet-laying to create a free-standing film or coating on a substrate from which the cellulosic film is not removed. The cellulosic film formed in the present methods should be understood as having two opposing primary surfaces. Accordingly, the cellulosic film may be a film or a coating, and is most preferably a film. The cellulosic film has a gram mage of between 1-80, preferably between 10-50 gsm, such as e.g. 10-40 gsm. For coatings in particular, the gram mage can be low, e.g. 0.1-20 gsm or more preferably even 0.1-10 gsm.

In one aspect of the methods described herein, the cellulosic film is surface-treated after it has been dried, e.g. while it has a solid content of 40-99.5% by weight, such as e.g. 60-99% by weight, 80-99% by weight or 90-99% by weight.

In another aspect of the methods described herein, the cellulosic film is surface-treated before it has been dewatered and dried, e.g. while it has a solid content of 0.1-80% by weight, such as e.g. 0.5-75% by weight or 1.0-50% by weight.

In one aspect of the methods described herein, the cellulosic film has been formed by wet-laying, preferably on a porous wire in a paper or paperboard machine and has a solid content of 50-99% by weight.

In another aspect of the methods described herein, the cellulosic film has been formed by casting and has a solid content of 50-99% by weight.

In another aspect of the methods described herein, the cellulosic film is surface-treated after it has been dried, e.g. while it has a solid content of 50-99% by weight, such as e.g. 60-99% by weight, 80-99% by weight or 90-99% by weight.

In another aspect of the methods described herein, the cellulosic film is surface-treated before it has been dried, e.g. while it has a solid content of 0.1-50% by weight, such as e.g. 1-40% by weight or 10-30% by weight.

The cellulosic film may include other cellulosic components. For instance, the cellulosic film may comprise other anionic microfibrillated cellulose (derivatized or physically grafted with anionic polymers) in the range of 1-50 wt %.

The cellulosic film to be surface treated may comprise 5-99 wt % native (non-derivatized) microfibrillated cellulose.

The amount of pulp fibers and coarse fines can be in the range of 0-60 wt %. The amount of pulp fibers and fines may be estimated afterwards e.g. by disintegrating a dry or wet sample, followed by fractionation and analysis of particle sizes of the fractions. Preferably, a never-dried furnish is fractionated and analysed in order to determine the amount of fines and fibers, respectively.

The cellulosic film may also comprise one or more fillers, such as a nanofiller, in the range of 1-50% by weight. Typical nanofillers can be nanoclays, bentonite, silica or silicates, calcium carbonate, talcum, etc. Preferably, at least one part of the filler is a platy filler. Preferably, one dimension of the filler should have an average thickness or length of 1 nm to 10 μm. If determining the particle size distribution of fillers for example with light scattering techniques, the preferred particle size should be that more than 90% is below 2 μm.

The surface-treated cellulosic film preferably has a surface-pH of 3-12 or more preferred a surface-pH of 5.5-11. More specifically, the surface-treated cellulosic film may have a surface-pH higher than 3, preferably higher than 5.5. In particular, the surface-treated cellulosic film may have a surface-pH less than 12, preferably less than 11.

The pH of the surface of the cellulosic film is measured on the final product, i.e. the dry product. “Surface-pH” is measured by using fresh pure water which is placed on the surface. Five parallel measurements are performed and the average pH value is calculated. The sensor is flushed with pure or ultra-pure water and the paper sample is then placed on the moist/wet sensor surface and pH is recorded after 30 s. Standard pH meters are used for the measurement.

Before surface treatment, the cellulosic film suitably has an Oxygen Transmission Rate (OTR) value in the range 100-5000 cc/m²/24 h (38° C., 85% RH) according to ASTM D-3985 at a grammage between 10-50 gsm, more preferably in the range of 100-1000 cc/m²/24 h.

The substrate suitably comprises 10-100 wt % MFC, such as at least 40% w/w MFC, preferably at least 60% w/w MFC, more preferably at least 80% w/w MFC.

The grammage of the cellulosic film is preferably 10-50 gsm. Typically, such substrates have basically no or very low WVTR barrier. The substrate may therefore have a WVTR (at 23° C. and 50% RH) prior to application of said first surface treatment composition of greater than 100 g/m2/d, preferably greater than 200 g/m2/d and more preferably greater than 500 g/m2/d.

The substrate may be translucent or transparent. In some embodiments, the MFC film has a transparency of at least 65%, preferably at least 75%, or more preferably at least 80% as measured according to the standard DIN 53147.

The profile of the substrate is controlled by e.g. even moisture profile or by supercalendering or by re-moisturizing and re-drying. The method disclosed herein may therefore further comprise a step of calendaring the cellulosic film prior to applying said first surface treatment composition.

The cellulosic film comprises at least 20% w/w MFC, preferably at least 40% w/w MFC, more preferably at least 60% w/w MFC, even more preferably at least 80% w/w MFC, most preferably 100% MFC.

Barrier Coating Composition

In the second step of the method, a barrier coating composition is applied on a surface of the cellulosic film. This can take place in one step:
by (a) applying a barrier coating composition to at least one surface of said cellulosic film; said barrier coating composition comprising a crosslinking agent and carboxymethyl cellulose (CMC)

or in two separate steps:
by (b) applying an aqueous solution comprising a crosslinking agent and an aqueous solution and/or suspension comprising carboxymethyl cellulose (CMC) to the same surface of said cellulosic film.

Preferably, the barrier coating composition is applied in one step; i.e. by applying a barrier coating composition comprising a crosslinking agent and carboxymethyl cellulose (CMC). If two steps are present, it is preferred that the CMC solution/suspension is applied first, followed by the aqueous solution comprising a crosslinking agent. Optionally, the aqueous solution comprising a crosslinking agent also comprises a hydrophilic polymer e.g. CMC.

A barrier coating composition is also provided, said barrier coating composition comprising a crosslinking agent and carboxymethyl cellulose (CMC).

The barrier coating composition of the invention is preferably a solution of CMC and crosslinking agent, although it may also be in the form of a suspension of one component (typically CMC with a low degree of substitution, DS, is more difficult to dissolve).

Suitably, the barrier coating composition is an aqueous solution of CMC and said crosslinking agent. In one aspect, the barrier coating composition is formed by adding dry CMC to an aqueous solution comprising said crosslinking agent. The barrier coating composition typically has a pH between 2-10, preferably between 2.5-8 and more preferably between 3-7. The pH of the barrier coating composition can be adjusted before or during or after adding the CMC. The preferred chemicals for pH adjustment are e.g. NaOH, KOH or Ca(OH)₂ or other basic chemicals.

In one aspect, the coating composition comprises an additional water-soluble polymer. Suitably, this additional water-soluble polymer is also able to crosslink by means of the crosslinking agents (e.g. organic acids such as citric acid) of the invention. Examples of these may be polyvinyl acetate (PVA) or polyvinyl alcohol (PVOH).

A barrier coating composition comprising CMC and citric acid in a 1:1 w/w ratio typically has a Brookfield viscosity which is less than 2000 mPas when measured at room temperature at 100 rpm, when the solids content is at least 10 wt %, more preferably at least 12 wt % or most preferably at least 15 wt %.

One preferred way to make the barrier coating composition is to mix dry CMC into a solution of water and crosslinker (such as acid, preferably citric acid). In known methods, cross-linker is added to a wet slurry of CMC.

Various types of mixers can be used to create the barrier coating compositions, including traditional blade mixers, rotor stator mixers, high shear homogenizators, ultrasonic mixers or combinations of one or several mixers. The benefit of mixing is that high shear and efficient mixing allows more even flowability and fewer agglomerates (e.g. non-dissolved CMC). High-shear mixing of low DS CMC may actually increase the viscosity which is due to the fact that the particles are disintegrated into minor components having more efficient thickening effect.

The total dry content of the coating composition is preferably more than 5 wt %, preferably more than 8 wt % and most preferably more than 10 wt %. The total dry solids content of the coating composition is typically about 14 wt %. This means that it contains both CMC and salts and possibly other additives. Other additives which may be included in the coating composition include e.g. nanoparticles, fillers, reinforcement fibers, other polysaccharides such as starch. Lubricating agents or softening agents, such as sorbitol or glycerol, may also be included. Further additives may be alkyl ketene dimer (AKD) or rosin size, which increase the hydrophobic nature of the barrier coating composition.

One aim of the coating compositions is to achieve high consistency, without adding inorganic filler. Therefore, the content of inorganic filler in the coating composition should be less than 20 wt % and more preferably less than 10 wt %.

To achieve high consistency (i.e. high solids), the following parameters are typically of relevance:
Low Mw CMC
Chemically or mechanically or thermally or biologically degrade NaCMC or any combination of those
Use an organic acid
Correct order of combination
High salt content in the CMC (preferably>1 wt %, more preferably>5 wt % and most preferably>10 wt %)
High temperature of mixing (preferably>20° C., more preferably>30° C. and most preferably>40° C.)

Consistency (i.e. solids content) can be determined using normal standards in papermaking, such as drying samples in an oven at 105° C. for at least 3 hours and then cooling in a desiccator before weighing. High consistency is required for many reasons, mainly to reduce drying cost but also in order to enable higher manufacturing capacity and to ensure less use of water. Without being bound to any theories, it is also believed that the high consistency influences the coating hold out and hence the barrier properties.

The CMC used in the present invention suitably has a weight average molecular weight of less than 50 000 mol/g, preferably less than 30 000 mol/g and more preferably less than 20 000 mol/g. Examples of such commercial products are e.g. Finnfix 10 from CPKelco or Finnfix 5 or Finnfix 2. Mw can be determined with various techniques, such as using gel permeation chromatography (GPC).

One interesting parameter is the degree of substitution, i.e. to which extent the cellulose is derivatised. The CMC according to one aspect has a degree of substitution (DS) from 0.05 to 0.5, preferably from 0.1 to 0.3. Typically, degree of substitution (DS) is determined e.g. by titration methods such as disclosed in Ambjornsson et al., (2013), Bioresources, 8(2), 1918-1932. It should be understood that salt content etc. will affect the titration results and therefore DS should be tested for blanks and for washed products. Without being bound to any theories, we believe that—due to the characteristic fiber and fibril structure—low DS CMC provides a better hold-out and hence more effective protective coating. A better “hold-out” means that the coatings stay better on the surface—thus a more effective coating can be achieved at a lower weight coat.

Crosslinking Agent

The crosslinking agent serves to crosslink the CMC during the curing step. It is preferred that the crosslinking agent is also able to crosslink MFC, and to crosslink between CMC and MFC, thereby increasing the integrity of the coated cellulosic film. Therefore, the crosslinking agent crosslinks particularly the coating, but also cross-links the coating with the base substrate (cellulosic film comprising MFC) and even to some extent within the base substrate itself. Suitably, the crosslinking agent is selected from an organic acid, preferably an organic polyacid. An “organic acid” is an organic molecule comprising a carboxylic acid moiety (—CO₂H), while an “organic polyacid” is an organic molecule comprising more than one of such carboxylic acid moieties. Suitably the organic acid or polyacid is selected from citric acid, lactic acid, acetic acid, formic acid, oxalic acid, 1,2,3,4-butanetetracarboxylic acid, malonic acid, tartaric acid, uric acid, or malic acid, preferably citric acid. The barrier coating composition may comprise a mixture of two or more crosslinking agents.

The concentration of the crosslinking agents in the barrier coating composition is typically 1-100 wt % or preferably 5-80 wt % and more preferably 10-70 wt % based on the dry weight of CMC in said barrier coating composition.

Application of the Barrier Coating Composition

The barrier coating composition is applied to the cellulosic film in an amount of 0.5-10 gsm, preferably 1-5 gsm, more preferably about 2 gsm. Once the barrier coating composition is applied, it is cured so as to form a barrier layer coated on said cellulosic film; i.e. a coated cellulosic film.

By “curing” is meant that a sample is heated and/or water is removed to such an extent that a crosslinking reaction occurs. The degree of crosslinking could be determined by e.g. spectroscopic means. Curing typically takes place by heating e.g. to at least 100° C., preferably to at least 120° C., or by some other method for removing water.

Typical techniques for coating application are those common in the field of papermaking or paper converting. The application may be performed by immersing, spraying, curtain, size press, film press, blade coating, rotogravure, inkjet, or other non-impact or impact coating methods. The coating application may be performed under pressure and/or under ultrasound. In this manner, the degree of penetration of the coating composition into the cellulosic film can be controlled. Coating may be applied online or offline.

The method described herein may include one or more additional steps. For instance, they may further comprise the step of rinsing or immersing the coated or uncoated cellulosic film in rinsing fluid following the coating application. Preferably, the methods further comprise the step of drying at elevated temperature and/or pressure following the surface treatment and/or the rinsing step.

The barrier coating composition is—according to one aspect—applied to both opposing surfaces of said cellulosic film. In another aspect, steps b. and c. of the method may be repeated such that more than one, such as e.g. 2, 3, 4, 5 or 10 barrier layers are formed on the cellulosic film. In one preferred aspect, different barrier layers comprise different amounts of crosslinking agent.

The cellulosic film suitably has a Gurley Hill value before being coated of at least 1000 s/100 ml and less than 42 300 s/100 ml and a Gurley Hill value after being coated of more than 10 000 s/100 ml, preferably more than 20 000 s/100 ml and more preferably more than 42300 s/100 ml according to ISO 5636-5. In another embodiment, the Gurley Hill value is non-measurable, i.e. too high to measure according to ISO 5636-5.

The coated cellulosic film is suitably dried to a moisture content of less than 25 wt %, preferably less than 20 wt %, more preferably less than 15 wt % and even more preferably less than 10 wt %.

The method may comprise the additional step of post-curing the coated cellulosic film. In the below experiments, post-curing was simulated by placing the samples in an oven for 5 minutes. Post-curing is preferably done with extended drying. The moisture content of the coated cellulosic film after post-curing is less than 6%, preferably less than 5% and more preferably less than 4%. Examples of extended drying processes are:
Contact dryers and/or IR
Yankee dryer
Extended drying belt, e.g. condebelt

Coated Cellulosic Film

A coated cellulosic film comprising MFC is provided, said cellulosic film being coated on at least one surface thereof with at least one cured barrier layer, wherein said cured barrier layer comprises CMC which has been crosslinked with a crosslinking agent. All details relating to the CMC, the crosslinking agent, the MFC and the film set out above are relevant to the coated cellulosic film of the invention, mutatis mutandis.

In various preferred aspects, therefore:
the cellulosic film comprises at least 20% w/w MFC, preferably at least 40% w/w MFC, more preferably at least 60% w/w MFC, even more preferably at least 80% w/w MFC, most preferably 100% MFC
the crosslinking agent is an organic acid, preferably an organic polyacid, suitably an organic acid selected from citric acid, lactic acid, acetic acid, formic acid, oxalic acid, uric acid, fumaric acid or malic acid, 1,2,3,4-butanetetracarboxylic acid, malonic acid or tartaric acid, preferably citric acid
the barrier layer comprises CMC which has been crosslinked with a mixture of two or more crosslinking agents
the barrier coating composition is coated in an amount of 0.5-10 gsm, preferably 1-5 gsm, more preferably about 2 gsm
barrier coating composition is coated on both opposing surfaces of said cellulosic film
the cellulosic film comprises more than one, such as e.g. 2, 3, 4, 5 or 10 barrier layers formed on the cellulosic film
the cellulosic film has a weight of 10-70 gsm, preferably 15-60 gsm and more preferably 20-50 gsm, even more preferably 20-35 gsm, before coating.
the coated cellulosic film has a Gurley Hill value of more than 10 000 s/100 ml, preferably more than 20 000 s/100 ml and more preferably more than 42300 s/100 ml according to ISO 5636-5.
the coated cellulosic film has a moisture content of less than 25 wt %, preferably less than 20 wt %, more preferably less than 15 wt % and even more preferably less than 10 wt %.

The coated cellulosic films of the present invention have features which are different e.g. from greaseproof papers and glassine papers, such as
Higher transparency
Lower WVTR (or better/improved water vapour barrier)
Lower OTR (or better/improved oxygen barrier)

The present invention has been described with reference to a number of aspects and embodiments. These aspects and embodiments may be combined at will by the person skilled in the art while remaining within the scope of the patent claims.

### EXAMPLES

### Example 1 (Comparative)

In this example, a 32 gsm cellulosic film comprising MFC was used. The base substrate used in this study was a mixture of MFC and softwood fibers, 75/25. MFC was made from bleached kraft pulp and fibrillated to a Schopper-Riegler value of 94. The softwood fibers were bleached kraft pulp which were refined to SR of 20. The base paper was substantially free from inorganic materials having an ash content of less than 5 wt %.

### Example 2

In this example, the blank experiment was made by surface sizing the above web on a pilot machine using only water as the surface sizing composition. The WVTR was 149 g/m²/d before curing treatment and 53 g/m²/d after curing treatment when determined at 23° C. and 50% RH. The curing denotes to heating in a laboratory oven (150° C./5 min) prior to evaluating the barrier properties.

### Example 3

In this example, citric acid was mixed with a high purity grade CMC (Cekol 150, CP Kelco) having high viscosity in a range of 150-300 mPas at 25° C. and at 2 wt % concentration when measured with a Brookfield LV viscosimeter). NaCMC content is min. 99.5 wt % and the degree of substitution is 0.75-0.85 according to the supplier.

The suspension had a solid content of 7.23 wt % and pH of 4. The coating was made with the same surface size press as used in example 2. After the coating, the substrate was dried but not calendered. Post-curing was done in same way as in example 2. The results from WVTR (23° C. and 50% RH) shows that significant reduction in the WVTR value is obtained.

### Example 4

In this example, the same recipe and conditions were used as in Example 3, but with the difference that the dry solid content of the suspension was reduced by approximately 50%. This reduced also the suspension viscosity but no positive effect of WVTR value was seen.

### Example 5

In this example, the high purity grade NaCMC was replaced with a low DS NaCMC grade which was a technical grade containing high amount of residual salts. The degree of substitution was 0.25. The pH of the Low DS NaCMC/citric acid solution was adjusted to 4 before coating and dried in a same way as in the previous examples. The measured WVTR value was at the same level as the previous examples.

### Example 6

In this example, the above formulation procedure was changed so that dry powder of low DS CMC was first dispersed into a 1 wt % citric acid solution after which the rest of the citric acid was added to obtain the desired ratio of 50:50 (w/w). The pH of the solution was 4, while the solid content could be increased to more than 12% without a negative impact on runnability or flowability. The measured WVTR was slightly improved compared to Example 5.

### Example 7

In this example, a high viscosity NaCMC was used (Finnfix 300, CP Kelco) and mixed with citric acid (50:50, w/w) in similar manner as in Example 3. According to the product specification, the viscosity was 150-400 mPas at 2 wt % (25° C.) when measured with Brookfield LV viscosimeter. This is comparable with Example 3. The WVTR results confirms the findings of Example 3.

### Example 8

In this example, the same recipe used in Example 7 was used but diluted approximately 50% before applied with the surface sizing press.

### Example 9

In this example, a low viscosity NaCMC (Finnfix 10 having a viscosity in a range of 50-200 mPas at 25° C. and at 4 wt-% concentration) solution was used together with citric acid. Same procedure as in the previous experiments was used, i.e. the amount of citric acid was 50% (w/w). The viscosity of the NaCMC-CA mixture was 447 mPas at a solid content of 12.2 wt %. The measured WVTR value was significantly lower than the WVTR measured for the trial points comprising NaCMC grade with higher viscosity.

### Example 10

In this example, the same formulation as in Example 9 was used but now the pH was adjusted to 4 using NaOH. The WVTR value was on a same level as in the example 9, and after post-curing it was further reduced to about 14 g/m²/day.

TABLE I

| | | WVTR, g/ | | OTR, cc/ | OTR, cc/ | | | | Dry | |
|---|---|---|---|---|---|---|---|---|---|---|
| | | m²/day | | m²/day | m²/day, | Brookfield- | | | cont- | |
| | | 23° C./50% RH | | 23° C./50% RH | 38° C./85% RH | viscosity, | Temp., | | ent, | |
| | | Before | After | Before | Before | mPas | ° C. | pH | wt-% | CA, |
| # | Surface size | curing | curing | curing | curing | Coating color | | | | wt-% |
| 1 | no surface sizing | 155 | | 10 | | | | | | |
| 2 | Water | 149 | 53 | 5.7 | 89 | 5.7 | 31.1 | 7.2 | 0 | 0 |
| 3 | CA/Cekol 150 pH 4 (50/50) | 69 | 30 | | 115 | 2322 | 27.6 | 4 | 7.23 | <3.6 |
| 4 | CA/Cekol 150 pH 4 (50/50) | 81 | | | 168 | | | 4.1 | 3.77 | <1.9 |
| 5 | CA/fibrillated low DS CMG | 76 | | | | 133.5 | 29 | 4 | 7.04 | <3.5 |
| | pH 4 (50/50) | | | | | | | | | |
| 6 | CA/fibrillated low DS CMC | 61 | 29 | | | 741.6 | 25.5 | 4 | 11.26 | <5.6 |
| | in 1% CA pH 4 (50/50) | | | | | | | | | |
| 7 | CA + FF-300 pH 4 (50/50) | 77 | | | 127 | 397.5 | 25.5 | 4 | 5.45 | <2.7 |
| B | CA + FF-300 pH 4 (50/50) | 86 | | | | | | 41 | 2.73 | <1.3 |
| 9 | CA + FF-10 (50/50) | 34 | | | 132 | 447.1 | 22.3 | 2.9 | 12.16 | 6.08 |
| 10 | CA + FF-10 (50/50) pH 4 | 34 | 13.7 | | | | | 4.1 | 14.41 | <7.2 |

1. A method for improving the barrier properties of a cellulosic film comprising microfibrillated cellulose (MFC), said method comprising the steps of:
a. providing a cellulosic film comprising MFC;
b. applying a barrier coating composition to at least one surface of said cellulosic film; said barrier coating composition comprising a crosslinking agent and carboxymethyl cellulose (CMC),
or
applying both an aqueous solution comprising a crosslinking agent and an aqueous solution and/or suspension comprising carboxymethyl cellulose (CMC) to the same surface of said cellulosic film and, thereby forming a barrier coating composition on said surface of the cellulosic film; and
c. curing said barrier coating composition so as to form a barrier layer coated on said cellulosic film

2. The method according to claim 1, wherein said cellulosic film comprises at least 20% w/w MFC.

3. The method according to claim 1, wherein said crosslinking agent is an organic acid.

4. The method according to claim 1, wherein said barrier coating composition is an aqueous solution or aqueous suspension of CMC and said crosslinking agent.

5. The method according to claim 1, wherein the concentration of the crosslinking agents in the barrier coating composition is 1-100 wt % based on a dry weight of CMC in said barrier coating composition.

6. The method according to claim 1, wherein a dry content of CMC in the barrier coating composition is at least 5 wt %.

7. The method according to claim 1, wherein the barrier coating composition comprises a mixture of two or more crosslinking agents.

8. The method according to claim 1, wherein the barrier coating composition is formed by adding dry CMC to an aqueous solution comprising said crosslinking agent.

9. The method according to claim 1, wherein the barrier coating composition has a pH between 2-10.

10. The method according to claim 1, wherein said barrier coating composition is applied in an amount of 0.5-10 gsm.

11. The method according to claim 1, wherein said CMC has a weight average molecular weight of less than 50,000 mol/g.

12. The method according to claim 1, wherein said barrier coating composition is applied to both opposing surfaces of said cellulosic film.

13. The method according to claim 1, wherein steps b. and c. are repeated such that more than one barrier layers are formed on the cellulosic film

14. The method according to claim 1, wherein the cellulosic film has a weight of 10-70 gsm before coating.

15. The method according to claim 1, wherein the cellulosic film has a Gurley Hill value, before being coated of at least 1,000 s/100 ml and less than 42,300 s/100 ml and a Gurley Hill value after being coated of more than 10,000 s/100 ml, according to the ISO5636-5.

16. The method according to claim 1, wherein the coated cellulosic film is dried to a moisture content of less than 25 wt %.

17. The method according to claim 1 further comprising the step of post-curing the coated cellulosic film.

18. A cellulosic film comprising:
MFC, said cellulosic film being coated on at least one surface thereof with at least one cured barrier layer, wherein said at least one cured barrier layer comprises CMC which has been crosslinked with a crosslinking agent.

19. A barrier coating composition, said barrier coating composition comprising:
a crosslinking agent and carboxymethyl cellulose (CMC).

20. The barrier coating composition according to claim 19, wherein said crosslinking agent is an organic acid.

21. The barrier coating composition according to claim 19, wherein said barrier coating composition is an aqueous solution or aqueous suspension of CMC and said crosslinking agent.

22. A method for manufacturing the barrier coating composition according to claim 19, said method comprising the step of:
adding dry CMC to an aqueous solution comprising said crosslinking agent.

23. The method according to claim 22, wherein the crosslinking agent is an acid.
